(19) United States
(12) Patent Application Publication
(10) Pub. No.: US 2008/0207793 A1
(43) Pub. Date: Aug. 28, 2008

(54) Coatings Reparable by Introduction of Energy

(75) Inventors: Yvonne Heischkel, Mannheim (DE); Harald Larbig, Rosenheim (DE); Erich Beck, Ladenburg (DE); Nick Gruber, Mannheim (DE); Reinhold Schwalm, Wachenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF, Ludwigshafen (DE)

(21) Appl. No.: 11/995,282

(22) PCT Filed: Jul. 12, 2006
(86) PCT No.: PCT/EP2006/064131

§ 371 Date: Jan. 10, 2008

(30) Foreign Application Priority Data
Jul. 19, 2005 (DE) 10 2005 034 213.2

(51) Int. Cl. C08F 2/46; C08G 18/00; C08G 63/00

(52) U.S. Cl. 522/90; 528/44; 525/452; 525/419; 525/55

(57) ABSTRACT

Coating compositions repairable by introduction of energy, coatings obtained therewith and repairable by introduction of energy, methods of producing them, and their use.

The present invention relates to coating compositions repairable by introduction of energy, to coatings obtained therewith and repairable by introduction of energy, to methods of producing them, and to their use.

Thin, self-healing polymer layers produced via self-assembly methods known to the skilled worker are described in P. Bertrand, A. Jonas, A. Laschewsky, R. Legras, Macromol. Rap. Comm. (2000), 21 (7), pp. 319-348. The polymer films are only able to heal again purely physically after suffering damage, by virtue of rearrangement of the ionically charged polymer chains. This high ion content on the part of the film has deleterious consequences for the chemical resistance of the coatings.

A two-component polyurethane coating material capable of healing scratches is described by WO 97/45475. The components consist of a water-dispersible polyisocyanate and a water-dispersible polymer having an OH number of 10-450 mg KOH/g.

A disadvantage of this disclosure is that the hydroxyl-bearing polymer makes no particular contribution to the self-healing (see comparative example).

The coating described by WO 2002/88215 is able to heal scratches only for a short time after application, and is used as a refinish material.

A disadvantage of the coatings disclosed here is that the hydroxyl-containing compounds used in the coatings comprise aliphatic hydroxyl groups, whose corresponding urethanes exhibit a significant self-healing effect only at a very high temperature above about 200° C.

A physical self-healing effect can also be achieved by using polysiloxanes that are reactive toward polyisocyanates, as in WO 96/10595 A1. Also described is the use of blocked polyisocyanates, which are then able to react with a polyol component. Polyols described, however, are merely normal polyacrylate polyols, which make no particular contribution to the self-healing (see comparative example).

Coatings based on polyurethanes are likewise used in order to heal scratches on glass. They make use of the flowability of the polyurethanes in the film. For this utility, mention may be made, by way of example, of U.S. Pat. No. 4,584,229, EP 135404 A1, DE 2634816, and EP 635348 A1.

All of the prior-art self-healing coating systems described to date make use solely of a physical residual flowability of a coating after curing in order to heal scratches that have formed. Sufficiently high flowability of the coatings, however, presupposes a low crosslinking density. This leads to inadequate mechanical resistance properties, failing, for example, to meet the requirements for automotive applications in terms of scratch resistance or chemical resistance.

Only EP 355 028 A describes true chemical self-healing of a coating. In this case a lower coating film comprises an aromatic ketone, which on UV exposure or under the effect of sunlight brings about the crosslinking of lower coating films and hence produces healing of mechanical defects through the formation of new chemical bonds. A disadvantageous effect here is the deficient selectivity in the forging of new crosslinking points, since crosslinking may progress in the coating and then leads to embrittlement.

Additionally, Wudl et al. describes systems based on Diels-Alder reaction products. A disadvantage here is that each Diels-Alder addition is accompanied by formation of a double bond which is unstable to weathering (Chen X. X.; Dam M. A., Ono K, Mal A., Shen H. B, Nutt S. R., Sheran K, Wudl F. “A thermally re-mendable cross-linked polymeric material”, Science, 2002, 295, 1698-1702).

It is an object of the present invention to provide coatings which are repairable by introduction of energy, whose scratch resistance at least matches that of the known, prior-art coatings and whose reparability, brought about by means of introduction of energy, is improved as compared with that of comparable coatings.

This object is achieved by means of coating compositions comprising as constituent components
A) at least one compound having isocyanate-reactive groups (Y) whose reaction product with isocyanate is more readily cleavable than the corresponding reaction product with a compound having primary hydroxyl groups, and also, if appropriate, having at least one further isocyanate-reactive group (Z), which is different from (Y), and
B) at least one di- or polyisocyanate.

Cleavage of the bond between isocyanate groups and groups (Y) is accomplished by introduction of heat and/or high-energy radiation and/or by application of pressure, preferably by introduction of heat and/or high-energy radiation, and more preferably by introduction of heat, such as thermally or by NIR radiation, for example. Under the cleavage conditions the groups (Y) and also isocyanate groups are at least partly reformed and can be newly linked again. In the cleaved state, therefore, the coating material is more readily flowable than the coating, scratches are able to heal by flow of the relatively low-viscosity coating composition, and after the end of the introduction of energy the coating composition is able to crosslink by renewed forging of the bonds between the groups (Y) and isocyanate groups.

For the purposes of this text the coating composition means the uncured composition comprising coating medium (binder) and, if appropriate, pigment and/or other, typical coatings additives.

The coating means the applied and dried and/or cured coating composition.

The term “easily cleavable” means here that the cleavage reaction of the reaction product into groups (Y) and isocyanate groups under the selected reaction conditions takes place at a rate which is more rapid than that of the cleavage of the corresponding reaction product with a compound having primary hydroxyl groups, especially methanol.

The compounds A) of the invention comprise at least two isocyanate-reactive groups (Y) whose reaction product with isocyanate is readily cleavable, and also, if appropriate, at least one further isocyanate-reactive group (Z).

In one alternative embodiment compounds A) may be a mixture of compounds comprising exclusively in each case at least two isocyanate-reactive groups (Y) with compounds comprising exclusively isocyanate-reactive groups (Z).

It represents a particular advantage of compounds A) of the invention which comprise at least one group (Y) and at least one group (Z) in one molecule that the groups (Y) which have undergone cleavage are unable to escape from the coating since they are still joined via groups (Z) to the isocyanate-functional component (B).

In a further alternative embodiment the compounds A) may be compounds each comprising precisely one group (Y) and precisely one group (Z).

Isocyanate-reactive groups (Y) whose reaction product is readily cleavable with isocyanate are groups of the kind which may be used for blocking isocyanate groups.

Groups of this kind are described in D. A. Wicks, Z. W. Wicks, Progress in Organic Coatings, 36, 148-172 (1999), 41, 1-83 (2001), and 43, 131-140 (2001).

Preferred groups (Y) are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

These stated groups may be joined in any desired way with the stated compounds A).

Imidazolic groups as groups reactive toward isocyanate groups, identified here in abbreviated form as “imidazoles”, are known for example from WO 97/12924 and EP 159117; triazoles from U.S. Pat. No. 4,482,721; CH-acidic cyclic ketones are described for example in DE-A1 102 60 269, particularly in paragraph [0008] therein and preferably in paragraphs [0033] to [0037], more preferably cyclopentanone-2-carboxylic esters, and particularly ethyl cyclopentanone-2-carboxylate.

Preferred imidazoles are, for example, imidazoles comprising not only the free NH group but also a further functional group, such as —OH, —SH, —NH—R, —NH₂, and/or —CHO, examples being 4-(hydroxymethyl)imidazole, 2-mercaptoimidazole, 2-amino-imidazole, 1-(3-aminopropyl)imidazole, 4,5-diphenyl-2-imidazolethiol, histamine, 2-imidazolecarboxaldehyde, 4-imidazolecarboxylic acid, 4,5-imidazoledicarboxylic acid, L-histidine, L-carnosine, and 2,2′-bis(4,5-dimethylimidazole).

Suitable triazoles are 3-amino-1,2,4-triazole, 4-amino-1,2,4-triazole, 3,5-diamino-1,2,4-triazole, 1H-1,2,4-triazole-3-thiol, 5-methyl-1H-1,2,4-triazole-3-thiol and 3-amino-5-mercapto-1,2,4-triazole.

Preference is given to phenols, oximes, N-hydroxyimides, lactams, imidazoles, triazoles, malonic esters, and alkyl acetonates, particular preference to lactams, phenols, imidazoles, triazoles, and malonic esters, and very particular preference to phenols.

Phenols here are those groups which are composed of at least one aromatic or heteroaromatic, preferably aromatic, ring system that carries at least one, preferably precisely one, phenolic hydroxyl group. The aromatic ring systems may be C₆ to C₂₀ aryl systems, which if appropriate may be substituted in any desired way by halogen, C₁ to C₂₀ alkyl, C₁ to C₂₀ alkyloyl, C₆ to C₂₀ aryloyl, C₁ to C₂₀ alkyloxycarbonyl, C₆ to C₂₀ aryloxycarbonyl, C₁ to C₂₀ alkylamidocarbonyl or C₆ to C₂₀ arylamidocarbonyl. In the case of heteroaromatic systems, one or more, one, two or three for example, preferably one or two, with particular preference one carbon atom(s) of an aromatic ring system may have been replaced by a nitrogen, oxygen or sulfur, preferably nitrogen, atom.

The compounds A) of the invention comprise on average at least 2, 2 to 20 for example, preferably 2 to 10, more preferably 2 to 6, very preferably 2 to 4, and in particular 2 to 3 groups (Y).

The groups (Y) within the compounds (A) can in each case be identical or different; preferably they are identical.

Groups (Y) can be present in compound A) in amounts up to 5 mol/kg of compound A), preferably 0.1 to 5 mol, more preferably 0.3 to 4.5 mol, very preferably 0.5 to 4 mol, and in particular 1 to 3 mol/kg.

The compounds A) may optionally further comprise at least one, one to six for example, preferably one to four, more preferably one to three, very preferably one to two, and in particular precisely one further isocyanate-reactive group (Z).

Groups (Z) are isocyanate-reactive groups which are other than the groups (Y). They may be, for example, primary hydroxyl, secondary hydroxyl, tertiary hydroxyl, primary amino or mercapto groups, preferably primary hydroxyl or primary amino groups, and more preferably primary hydroxyl groups.

Primary hydroxyl or amino groups are hydroxyl or amino groups attached to a carbon atom which is joined to precisely one other carbon atom. Similarly, in the case of secondary hydroxyl or amino groups, the carbon atom attached to them is joined, correspondingly, to two carbon atoms, and in the case of tertiary hydroxyl or amino groups to three carbon atoms.

The carbon atoms to which the hydroxyl or amino groups are attached may be cycloaliphatic or aliphatic carbon atoms, i.e., part of a cycloaliphatic ring system or of a linear or branched chain, but not of an aromatic ring system.

Groups (Z) can be present in compound A) in amounts up to 5.5 mol/kg of compound A).

In particular in the case of primary hydroxyl groups as groups (Z) the OH number may be 0-300 mg KOH/g in accordance with DIN 53240-2, preferably 0 to 250, more preferably 0 to 200, very preferably 10 to 150, and in particular 50 to 150.

The compounds A) may preferably be polyethers or polyetherols, polyesters or polyesterols, polyurethanes or polyacrylates, and also their esterification products with (meth)acrylic acid, which in this text is an abbreviation for methacrylic acid and acrylic acid, preferably acrylic acid, and they comprise groups (Y).

Polyethers or polyetherols as compounds A) are, for example, compounds synthesized from diols or polyols with, if appropriate, single or multiple alkoxylation. Additionally, at least one monomer bearing groups (Y) is copolymerized in such compounds A or forms the starter molecule for an alkoxylation.

Diols or polyols are ethylene glycol, 1,2-propanediol, 1,3-propanediol, 1,1-dimethyl-ethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclo-hexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclo-hexanedimethanol, 1,2-, 1,3- or 1,4-cyclohexanediol, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt.

Each hydroxyl group may independently of any other be alkoxylated one- to twentyfold, preferably one- to tenfold, more preferably one- to fivefold, very preferably one- to threefold, and in particular one- to twofold.

Examples of suitable alkylene oxides are ethylene oxide, propylene oxide, isobutylene oxide, vinyloxirane and/or styrene oxide; ethylene oxide and propylene oxide are preferred, and ethylene oxide is particularly preferred. The alkylene oxides can also be used in a mixture.

Additionally suitable is polyTHF having a molar mass of between 162 and 2000, polyethylene glycol having a molar mass of between 106 and 2000, poly-1,3-propylene glycol having a molar mass of between 134 and 2000, poly-1,2-propylene glycol having a molar mass of between 134 and 2000, and mixed polyethylene/1,2-propylene glycols having a molar mass of between 106 and 2000.

The resulting polyetherols can then be at least partly reacted, for example, with compounds having at least one group that is reactive toward hydroxyl groups, and at least one group (Y) or at least one group which can be converted into a group (Y).

Examples thereof are 2-hydroxybenzoic acid, 3-hydroxybenzoic acid, 4-hydroxybenzoic acid, 2-hydroxy-4-methylbenzoic acid, 4-hydroxy-3-nitrobenzoic acid, 2,3-dihydroxy-benzoic acid, 2,4-dihydroxybenzoic acid, 3,4-dihydroxybenzoic acid, 3,5-dihydroxy-benzoic acid, 2,4-dihydroxy-3,6-dimethylbenzoic acid, 3,4,5-trihydroxybenzoic acid, 5-hydroxyisophthalic acid or 4-hydroxyphthalic acid and also their anhydrides, C₁-C₄ alkyl ethers, and C₁ to C₄ alkyl esters. Preference is given to 4-hydroxybenzoic acid, 5-hydroxyisophthalic acid, and 4-hydroxyphthalic acid, and their tert-butyl ethers, and particular preference to 4-hydroxybenzoic acid.

C₁-C₄-Alkyl for the purposes of this text means methyl, ethyl, isopropyl, n-propyl, n-butyl, isobutyl, sec-butyl or tert-butyl.

For the reaction the polyetherols are then reacted at least in part with these stated compounds, preferably such as to give products A) comprising at least two groups (Y).

This achieves at least partial modification of the hydroxyl-containing polyetherols by reaction with, preferably, 4-hydroxybenzoic acid; in other words, at least some of the terminal hydroxyl groups are phenolic hydroxyl groups. If the phenolic hydroxyl groups are etherified, preferably tert-butyl-etherified, these protective groups can be eliminated in a subsequent step (see below).

The polyesters or polyesterols are the following compounds:

Polyester polyols are known for example from Ullmanns Enzyklopädie der technischen Chemie, 4th Edition, Volume 19, pp. 62 to 65. Preference is given to using polyester polyols obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are used. Preference is given to dicarboxylic acids of the general formula HOOC—(CH₂)_{y}—COOH, y being a number from 1 to 20, preferably an even number from 2 to 20, more preferably succinic acid, adipic acid, sebacic acid, and dodecanedicarboxylic acid.

Suitable polyhydric alcohols for preparing the polyesterols are the diols and polyols listed above in connection with the polyethers.

Preference is given to alcohols of the general formula HO—(CH₂)ₓ—OH, x being a number from 1 to 20, preferably an even number from 2 to 20. Preferred are ethylene glycol, butane-1,4-diol, hexane-1,6-diol, octane-1,8-diol, and dodecane-1,12-diol. Additionally preferred is neopentyl glycol.

Also suitable are polycarbonate diols such as may be obtained, for example, by reacting phosgene with an excess of the low molecular mass alcohols specified as constituent components for the polyester polyols.

Also suitable are lactone-based polyester diols, which are homopolymers or copolymers of lactones, preferably hydroxyl-terminated adducts of lactones with suitable difunctional starter molecules. Suitable lactones are preferably those deriving from compounds of the general formula HO—(CH₂)_{z}—COOH, z being a number from 1 to 20 and it also being possible for a hydrogen atom of a methylene unit to be substituted by a C₁ to C₄ alkyl radical. Examples are ε-caprolactone, β-propiolactone, gamma-butyrolactone and/or methyl-ε-caprolactone, 2-, 3- or 4-hydroxybenzoic acid, 6-hydroxy-2-naphthoic acid or pivalolactone, and also mixtures thereof. Suitable starter components are, for example, the low molecular mass dihydric alcohols specified above as a constituent component for the polyester polyols. The corresponding polymers of ε-caprolactone are particularly preferred. Lower polyester diols or polyether diols can also be used as starters for preparing the lactone polymers. In lieu of the polymers of lactones it is also possible to employ the corresponding, chemically equivalent polycondensates of the hydroxycarboxylic acids that correspond to the lactones.

Additionally at least one monomer bearing groups (Y) is copolymerized in the compound A.

The polyesterols may for example be reacted at least partly with compounds having at least one group that is reactive toward hydroxyl groups, and at least one group (Y) or at least one group which can be converted into a group (Y).

Examples thereof are 2-hydroxybenzoic acid, 3-hydroxybenzoic acid, 4-hydroxybenzoic acid, 2-hydroxy-4-methylbenzoic acid, 4-hydroxy-3-nitrobenzoic acid, 2,3-dihydroxybenzoic acid, 2,4-dihydroxybenzoic acid, 3,4-dihydroxybenzoic acid, 3,5-dihydroxybenzoic acid, 2,4-dihydroxy-3,6-dimethylbenzoic acid, 3,4,5-trihydroxybenzoic acid, 5-hydroxyisophthalic acid or 4-hydroxyphthalic acid and also their anhydrides, C₁-C₄ alkyl ethers, and C₁ to C₄ alkyl esters. Preference is given to 4-hydroxybenzoic acid, 5-hydroxyisophthalic acid, and 4-hydroxyphthalic acid, and their tert-butyl ethers, and particular preference to 4-hydroxybenzoic acid.

For the reaction the polyesterols are then reacted at least in part with these stated compounds, preferably such as to give products A) comprising at least two groups (Y).

The polyesters in question have a weight-average molar weight of 1000 to 50 000, preferably 2000 to 30 000, more preferably 3000 to 20 000, and very preferably 5000 to 15 000.

In the case of polyurethanes as compounds A the compounds in question are synthesized from reaction products of di- or polyisocyanates with diols or polyols, which if appropriate are alkoxylated one or more times and which then in their turn may be reacted, as described in connection with the polyetherols or polyesterols, with aromatic carboxylic acids that bear phenolic groups.

Isocyanates are, for example, aliphatic, aromatic, and cycloaliphatic di- and polyisocyanates having an NCO functionality of at least 1.8, preferably 1.8 to 5, and more preferably 2 to 4, and also their isocyanurates, biurets, urethanes, allophanates, and uretdiones.

The diisocyanates are preferably isocyanates having 4 to 20 carbon atoms and 2 NCO groups. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates, such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanato-methyl)cyclohexane (isophorone diisocyanate), 1,3- or 1,4-bis(isocyanato-methyl)cyclohexane, 2,4- or 2,6-diisocyanato-1-methylcyclohexane, 3 (or 4),8 (or 9)bis(isocyanatomethyl)tricyclo[5.2.1.0^{2,6}]decane isomer mixtures, and also aromatic diisocyanates such as 2,4- or 2,6-tolylene diisocyanate and the isomer mixtures thereof, m- or p-xylylene diisocyanate, 2,4′- or 4,4′-diisocyanatodiphenyl-methane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethyldiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Also possible, though less preferred, are monomeric isocyanates with more than 2 NCO groups.

Suitable polyisocyanates include those containing isocyanurate groups, those containing uretdione groups, those containing biuret groups, those containing urethane or allophanate groups, those comprising oxadiazinetrione groups, those comprising iminooxadiazinetrione groups, uretonimine-modified polyisocyanates based on linear or branched C₄-C₂₀ alkylene diisocyanates, cycloaliphatic diisocyanates having a total of 6 to 20 carbon atoms, or aromatic diisocyanates having in total 8 to 20 carbon atoms, or mixtures thereof.

The diisocyanates and polyisocyanates which can be used have an isocyanate group content (calculated as NCO, molecular weight=42) of preferably 10% to 60% by weight, based on the diisocyanate and polyisocyanate (mixture), more preferably 15% to 60% by weight, and very preferably 20% to 55% by weight.

Preference is given to aliphatic and cycloaliphatic diisocyanates and polyisocyanates, examples being the aforementioned aliphatic and cycloaliphatic diisocyanates, or mixtures thereof.

1,6-Hexamethylene diisocyanate, 1,3-bis(isocyanatomethyl)cyclohexane, isophorone diisocyanate, and di(isocyanatocyclohexyl)methane are preferred, 1,6-hexamethylene diisocyanate and isophorone diisocyanate particularly so; very particular preference is given to hexamethylene diisocyanate.

Preference extends to
1) Polyisocyanates containing isocyanurate groups and derived from aromatic, aliphatic and/or cycloaliphatic diisocyanates. Particular preference here is given to the corresponding aliphatic and/or cycloaliphatic isocyanato-isocyanurates and, in particular, to those based on hexamethylene diisocyanate and isophorone diisocyanate. The isocyanurates present are, in particular, trisisocyanatoalkyl or trisisocyanatocycloalkyl isocyanurates, which represent cyclic trimers of diisocyanates, or are mixtures with their higher homologs containing more than one isocyanurate ring. The isocyanato-isocyanurates generally have an NCO content of 10% to 30% by weight, in particular 15% to 25% by weight, and an average NCO functionality of 2.6 to 4.5.
2) Uretdione diisocyanates having aromatically, aliphatically and/or cycloaliphatically attached isocyanate groups, preferably aliphatically and/or cycloaliphatically attached isocyanate groups, and in particular those derived from hexamethylene diisocyanate or isophorone diisocyanate. Uretdione diisocyanates are cyclic dimerization products of diisocyanates.
   The uretdione diisocyanates can be used in the preparations of the invention as the sole component or in a mixture with other polyisocyanates, particularly those specified under 1).
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 22% by weight and an average NCO functionality of 2.8 to 4.5.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with mono- or polyhydric alcohols such as, for example, methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol, or polyhydric alcohols as recited above in connection with the polyesterols, or mixtures thereof. These polyisocyanates containing urethane and/or allophanate groups generally have an NCO content of 12% to 20% by weight and an average NCO functionality of 2.5 to 4.5.
5) Polyisocyanates comprising oxadiazinetrione groups, derived preferably from hexamethylene diisocyanate or isophorone diisocyanate. Polyisocyanates of this kind comprising oxadiazinetrione groups can be prepared from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.

The polyisocyanates 1) to 7) can be used in a mixture, including, if appropriate, a mixture with diisocyanates.

Suitable polyhydric alcohols for preparing the polyurethanes are the diols and polyols recited above in connection with the polyethers.

Inventively preferred compounds A are polyacrylates. Preferred polyacrylates of this kind comprise as constituent components
(a) at least one polymerizable compound having at least one group (Y) or at least one group which can be converted into a group (Y),
(b) at least one ester of a monoalcohol with (meth)acrylic acid,
(c) at least one compound other than (a) and (b) having precisely one free-radically polymerizable C═C double bond,
(d) if appropriate, at least one ester of an alcohol having more than one hydroxyl group with (meth)acrylic acid having precisely one free-radically polymerizable C═C double bond,
(e) if appropriate, compounds other than (d) having more than one free-radically polymerizable C═C double bond.

Compounds (a) are polymerizable compounds having at least one group (Y) or at least one group which can be converted into a group (Y).

These may be, for example, compounds comprising at least one, preferably precisely one, ethylenic C═C double bond which is joined to at least one, preferably precisely one, phenol, imidazole, triazole, pyrazole, oxime, N-hydroxyimide, hydroxybenzoic ester, secondary amine, lactam, CH-acidic cyclic ketone, malonic ester or alkyl acetoacetate, or which is joined to at least one, preferably precisely one, protected phenol, imidazole, triazole, pyrazole, oxime, N-hydroxyimide, hydroxybenzoic ester, secondary amine, lactam, CH-acidic cyclic ketone, malonic ester or alkyl acetoacetate.

Examples of groups which can be converted into a group (Y) are protected groups, for example O-alkylated, preferably O-tert-alkylated, O-acylated or O-silylated phenols, oximes, N-hydroxyimides, hydrobenzoic esters or N-sulfonated secondary amines.

Common protective groups for the aforementioned groups are described for example in Theodora W. Greene, Protective Groups in Organic Synthesis, 3rd ed., Wiley New York, 1999 or in Philip J. Kocienski, Protecting Groups, Thieme Stuttgart 2000.

Particularly preferred compounds (a) are protected styrene derivatives or cinnamic acid derivatives of the formula (I)

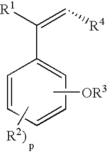

in which
R¹ and R⁴ independently of one another are hydrogen or methyl,
R⁴ is additionally carboxyl (—COOH) or an ester group (—COOR⁵),
R² and R⁵ independently of one another are C₁ to C₂₀ alkyl,
R³ is hydrogen, halogen, C₁ to C₂₀ alkyl, C₁ to C₂₀ alkyloyl, C₁ to C₂₀ aryloyl, C₁ to C₂₀ alkyloxycarbonyl, C₁ to C₂₀ aryloxycarbonyl, C₁ to C₂₀ alkylamidocarbonyl, C₁ to C₂₀ arylamidocarbonyl or trisubstituted silyl, and
p is 0 to 2, preferably 0 to 1, and more preferably 0,

it also being possible for groups —COOR⁵ and —OR³ together to form a —COO— group.

The C₁ to C₂₀ alkyl here may be unsubstituted or substituted and may for example be methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonyl-propyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

The C₁ to C₂₀ aryl may be unsubstituted or substituted and may, for example, be phenyl, tolyl, xylyl, α-naphthyl, β-naphthyl, 4-biphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethyl-phenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

Silyl may for example be trimethylsilyl, triethylsilyl, triphenylsilyl, tert-butyldimethylsilyl, tert-butyldiphenylsilyl, tert-butoxydimethylsilyl, tert-butoxydiphenylsilyl or thexyl-dimethylsilyl.

Halogen may be fluorine, chlorine or bromine, preferably chlorine.

R¹ is preferably hydrogen.

R³ is preferably tert-butyl, tert-amyl, benzyl, acetyl, benzoyl, trimethylsilyl, tert-butyloxycarbonyl, benzyloxycarbonyl or phenylamidocarbonyl, more preferably tert-butyl or tert-amyl.

The group —OR³ may be in position 2, 3 or 4 relative to the vinyl group, preferably in position 4.

If the group —OR³ is in position 4 then there are preferably no substituents positioned ortho to this group —OR³.

R¹ and R⁴ may be in either cis or trans configuration to one another.

Preferred compounds (a) are 4-methoxystyrene, 4-silyloxystyrene, 4-tert-butoxystyrene, 4-tert-amyloxystyrene, 4-acetoxystyrene, 4-hydroxycinnamic acid or coumarin, more preferably 4-tert-butoxystyrene. Also suitable are 1-(4-methoxy-phenyl)-1-propene, methylisoeugenol (1,2-dimethoxy-4-(1-propenyl)benzene, 1-(3,4-dimethoxyphenyl)-1-propene), and isoeugenol (1-(4-hydroxy-3-methoxy-phenyl)-1-propene).

Compounds (b) are esters of a monoalcohol with (meth)acrylic acid.

The monoalcohol may be aromatic, cycloaliphatic or, preferably, aliphatic; more preferably it is a cycloalkanol or alkanol, very preferably an alkanol.

Examples of monoalcohols are methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, cyclopentanol, cyclohexanol, cyclooctanol, cyclododecanol, ethylene glycol monomethyl ether, ethylene glycol monoethyl ether, and 1,3-propanediol monomethyl ether.

Preferred compounds (b) are methyl (meth)acrylate, ethyl (meth)acrylate, n-butyl (meth)acrylate, 2-ethylhexyl (meth)acrylate, cyclohexyl (meth)acrylate, and dihydrodicyclopentadienyl acrylate, more preferably methyl (meth)acrylate, ethyl (meth)acrylate, n-butyl (meth)acrylate and 2-ethylhexyl (meth)acrylate.

Compounds (c) are compounds that are different from (a) and (b) and have precisely one free-radically polymerizable C═C double bond.

Examples thereof are vinylaromatic compounds, e.g., styrene, α-methylstyrene,

α,β-unsaturated nitriles, e.g., acrylonitrile, methacrylonitrile,
α,β-unsaturated aldehydes, e.g., acrolein, methacrolein,
vinyl esters, e.g., vinyl acetate, vinyl propionate,
halogenated ethylenically unsaturated compounds, e.g., vinyl chloride, vinylidene chloride,
cyclic monounsaturated compounds, e.g., cyclopentene, cyclohexene, cyclododecene, N-vinylformamide,
allylacetic acid, vinylacetic acid,
monoethylenically unsaturated carboxylic acids of 3 to 8 carbon atoms and their water-soluble alkali metal, alkaline earth metal or ammonium salts, for example: acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid,

### N-vinylpyrrolidone,

N-vinyl lactams, e.g., N-vinylcaprolactam,
N-vinyl-N-alkylcarboxamides or N-vinylcarboxamides, such as N-vinylacetamide, N-vinyl-N-methylformamide, and N-vinyl-N-methylacetamide,
vinyl ethers, e.g. methyl vinyl ether, ethyl vinyl ether, n-propyl vinyl ether, isopropyl vinyl ether, n-butyl vinyl ether, sec-butyl vinyl ether, isobutyl vinyl ether, and tert-butyl vinyl ether,
and mixtures thereof.

Preferred compounds (c) are styrene, vinyl acetate, acrylonitrile, acrylic acid, N-vinylpyrrolidone, N-vinylcaprolactam and ethyl vinyl ether, more preferably styrene.

Compounds (d) are esters of an alcohol having more than one hydroxyl group with (meth)acrylic acid.

Examples of alcohols of this kind are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclo-hexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, 2,2-bis(4-hydroxycyclohexyl)propane, 1,1-, 1,2,1,3- and 1,4-cyclohexanedimethanol, 1,2-, 1,3- or 1,4-cyclohexanediol, trimethylolbutane, trimethylolpropane, trimethylolethane, pentaerythritol, glycerol, ditrimethylolpropane, and dipentaerythritol.

The alcohols may if appropriate be alkoxylated one to ten times, preferably one to five times, more preferably one to three times, and very preferably once or twice per hydroxyl group, preferably with ethoxylation and/or propoxylation, and more preferably with ethoxylation.

The compounds (d) may be compounds (d1), which apart from (meth)acrylate groups contain no other functional groups, or compounds (d2), which contain at least one other functional group.

Examples of such functional groups are hydroxyl groups, unsubstituted amino groups, N-monosubstituted amino groups, N,N-dialkyl-substituted amino groups, and thiol groups.

Preferred compounds (d1) are 1,2-ethanediol di(meth)acrylate, 1,2-propanediol di(meth)acrylate, 1,3-propanediol di(meth)acrylate, 1,4-butanediol di(meth)acrylate, 1,6-hexanediol di(meth)acrylate, neopentyl glycol di(meth)acrylate, trimethylolpropane tri(meth)acrylate, and pentaerythritol tetra(meth)acrylate.

Preferred compounds (d2) are 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, pentaerythritol tri(meth)acrylate, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, and 2-dimethylaminoethyl (meth)acrylate.

The compounds (d1) and (d2) can also be used as mixtures, examples being technical mixtures from the acrylation of pentaerythritol, which normally have an OH number to DIN 53240 of 99 to 115 mg KOH/g and are composed predominantly of pentaerythritol triacrylate and pentaerythritol tetraacrylate, and may also comprise minor amounts of pentaerythritol diacrylate.

Compounds (e) are compounds which if appropriate are different from (d) and have more than one free-radically polymerizable C═C double bond.

Examples thereof are divinylbenzene, butadiene, chloroprene or isoprene. The polyacrylates comprise the constituent components in general in the following amounts (in mol %):
(a) 0.1 to 50, preferably 0.5 to 40, more preferably 1 to 30, very preferably 5 to 25, and in particular 10 to 20 mol %,
(b) 50 to 99.9, preferably 60 to 99.5, more preferably 70 to 90, very preferably 75 to 95, and in particular 80 to 90 mol %,
(c) 0 to 50, preferably 1 to 40, more preferably 5 to 35, very preferably 10 to 30, and in particular 15 to 25 mol %,
(d) 0 to 5, preferably 0 to 4, more preferably 0 to 3, very preferably 0.1 to 2.5, and in particular 1 to 2 mol %,
(e) 0 to 5, preferably 0 to 4, more preferably 0 to 3, very preferably 0.1 to 2.5, and in particular 1 to 2 mol %,
   with the proviso that the sum is 100 mol %.

A frequent, though not the only, method of preparing (co)polymers of this kind is that of free-radical or ionic (co)polymerization in a solvent or diluent.

The free-radical (co)polymerization of such monomers takes place for example in aqueous solution in the presence of polymerization initiators which break down into free radicals under polymerization conditions, examples being peroxodisulfates, H₂O₂ redox systems or hydroxy peroxides, such as tert-butyl hydroperoxide or cumene hydroperoxide, for example. The (co)polymerization may be performed within a wide temperature range, if appropriate under reduced pressure or else under elevated pressure, generally at temperatures up to 100° C. The pH of the reaction mixture is commonly set in the range from 4 to 10.

Alternatively the co(polymerization) may be carried out in another way known per se to the skilled worker, continuously or batchwise, in the form for example of a solution, precipitation, water-in-oil emulsion, inverse emulsion, suspension or inverse suspension polymerization.

The monomer(s) is (are) (co)polymerized using free-radical polymerization initiators.

Examples are those as listed in Polymer Handbook ed. 1999, Wiley & Sons, New York.

They are, for example, peroxodisulfates, examples being potassium, sodium or ammonium peroxodisulfate, peroxides, examples being sodium peroxide or potassium peroxide, perborates, such as ammonium, sodium or potassium perborate, monopersulfates, such as ammonium, sodium or potassium hydrogen monopersulfate, and salts of peroxycarboxylic acids, examples being ammonium, sodium, potassium or magnesium monoperoxyphthalate.

It is also possible to use hydrogen peroxide, in the form for example of an aqueous solution, in a concentration of 10% to 50% by weight.

A further possibility is the use of tert-butyl hydroperoxide, tert-amyl hydroperoxide, cumyl hydroperoxide, peracetic acid, perbenzoic acid, monoperphthalic acid or meta-chloroperbenzoic acid.

It is further possible to use ketone peroxides, dialkyl peroxides, diacyl peroxides or mixed acyl alkyl peroxides.

Examples of diacyl peroxides are dibenzoyl peroxide and diacetyl peroxide.

Examples of dialkyl peroxides are di-tert-butyl peroxide, dicumyl peroxide, bis(α,α-dimethylbenzyl) peroxide, and diethyl peroxide.

An example of mixed acyl alkyl peroxides is tert-butyl perbenzoate.

Ketone peroxides are, for example, acetone peroxide, butanone peroxide, and 1,1′-peroxybiscyclohexanol.

Others are, for example, 1,2,4-trioxolane or 9,10-dihydro-9,10-epidioxidoanthracene.

Preference is given to azo compounds which break down into free radicals, such as 2,2′-azobis(isobutyronitrile), 2,2′-azobis(2-amidinopropane) hydrochloride or 4,4′-azobis(4′-cyanopentanoic acid), or dialkyl peroxides, such as di-tert-amyl peroxide, aryl alkyl peroxides, such as tert-butyl cumyl peroxide, alkyl acyl peroxides, such as tert-butyl peroxy-2-ethylhexanoate, peroxydicarbonates, such as di(4-tert-butyl-cyclohexyl) peroxydicarbonate, or hydroperoxides.

The constituent components are used mostly in the form of aqueous solutions or aqueous emulsions, the lower concentration being determined by the amount of water that is acceptable in the (co)polymerization and the upper concentration by the solubility of the respective compound in water.

Examples of compounds which may be used as solvents or diluents include water, alcohols, such as methanol, ethanol, n- or isopropanol, n- or isobutanol, glycols, ketones, such as acetone, ethyl methyl ketone, diethyl ketone or isobutyl methyl ketone. Particular preference is given to nonpolar solvents such as, for example, xylene and its isomer mixtures, Shellsol® A, and solvent naphtha. Further possibilities include esters or ketones. Examples thereof are n-butyl acetate, ethyl acetate, 1-methoxyprop-2-yl acetate, 2-methoxyethyl acetate, 2-ethoxyethyl acetate, 2-ethoxyethyl propionate or butyl glycol acetate.

In one preferred embodiment the monomers are premixed, and initiator, together if appropriate with further additions, is added as a solvent solution. One particularly preferred embodiment is described in WO 01/23484, in particular on page 10, lines 3 to 24 therein.

The (co)polymerization can if appropriate be conducted in the presence of polymerization regulators, such as hydroxylammonium salts, chlorinated hydrocarbons, and thio compounds, such as tert-butyl mercaptan, thioglycolic acid ethylacrylic esters, mercaptoethynol, mercaptopropyltrimethoxysilane, dodecyl mercaptan, tert-dodecyl mercaptan or alkali metal hypophosphites. In the (co)polymerization these regulators can be used, for example, in amounts of 0 to 0.8 part by weight, based on 100 parts by weight of the monomers to be (co)polymerized, and they lower the molar mass of the resultant (co)polymer.

For the emulsion polymerization it is possible to use dispersants, ionic and/or nonionic emulsifiers and/or protective colloids, and/or stabilizers, as surface-active compounds.

Suitable such compounds include not only the protective colloids that are normally used for implementing emulsion polymerizations, but also emulsifiers.

Examples of suitable protective colloids include polyvinyl alcohols, cellulose derivatives, or vinylpyrrolidone copolymers. An exhaustive description of further suitable protective colloids is found in Houben-Weyl, Methoden der organischen Chemie, Volume XIV/1, Macromolecular compounds, Georg-Thieme-Verlag, Stuttgart, 1969, pp. 411 to 420. It will be appreciated that mixtures of emulsifiers and/or protective colloids can also be used. As dispersants it is preferred to use exclusively emulsifiers, whose relative molecular weights, unlike those of the protective colloids, are usually below 1000. They may be anionic, cationic or nonionic in nature. As will be appreciated it is necessary, when using mixtures of surface-active substances, that the individual components be compatible with one another, something which in case of doubt can be checked by means of a few preliminary tests. Generally speaking, anionic emulsifiers are compatible with one another and with nonionic emulsifiers.

The same also applies to cationic emulsifiers, whereas anionic and cationic emulsifiers are usually incompatible with one another. Examples of customary emulsifiers include ethoxylated mono-, di-, and trialkylphenols (degree of ethoxylation: 3 to 100, C₄ to C₁₂), ethoxylated fatty alcohols (degree of ethoxylation: 3 to 100, alkyl radical: C₈ to C₁₈), and alkali metal and ammonium salts of alkyl sulfates (alkyl radical: C₈ to C₁₆) of sulfuric monoesters with ethoxylated alkylphenols (degree of ethoxylation: 3 to 100, alkyl radical: C₄ to C₁₂), of alkylsulfonic acids (alkyl radical: C₁₂ to C₁₈), and of alkylarylsulfonic acids (alkyl radical: C₉ to C₁₈). Further suitable emulsifiers, such as sulfosuccinic esters, are found in Houben-Weyl, Methoden der organischen Chemie, Volume XIV/1, Macromolecular compounds, Georg-Thieme Verlag, Stuttgart, 1961, pages 192 to 208.

In general the amount of dispersant used is 0.5% to 6%, preferably 1% to 3% by weight based on the monomers for free-radical polymerization.

The resulting polymers, polymer solutions or polymer dispersions may additionally be subjected to chemical and/or physical deodorization.

Any protective groups comprised in the compounds A are removed after the preparation of the latter and preferably prior to reaction with the compounds B. Common methods of removing the protective groups are described for example in Theodora W. Greene, Protective Groups in Organic Synthesis, 3rd ed., Wiley New York, 1999 or in Philip J. Kocienski, Protecting Groups, Thieme Stuttgart 2000.

In the case of the tertiary alkyl groups, in particular of phenols, the protective group-containing compounds A are heated preferably with at least one acid at a temperature of 20 to 100° C., preferably of 20 to 80° C., and more preferably of 40 to 70° C. over a period of 10 minutes up to several hours.

Suitable acids are sulfuric acid, phosphoric acid, mineral acids such as hydrochloric acid, for example, alkyl- or arylsulfonic acid, examples being methanesulfonic, trifluoromethanesulfonic, benzenesulfonic, para-toluenesulfonic or dodecyl-benzenesulfonic acid, carboxylic acids such as acetic acid, or strongly acidic ion exchangers.

Cleaving is performed preferably in the presence of at least one reducing agent, examples being those as described in WO 03/35596 from p. 5 l. 36 to p. 9 l. 7 and p. 13 l. 5 to l. 30. The presence is preferred of triphenylphosphine, triphenyl phosphite, hypophosphorous acid or triethyl phosphite, more preferably of hypophosphorous acid.

In one preferred embodiment the protective groups are cleaved under a gas which is inert under the reaction conditions.

In the case of acyl groups as protective groups, in particular of phenols, the protective group-containing compounds A are heated with at least one base, such as sodium hydroxide, potassium hydroxide or milk of lime, at a temperature of 20 to 100° C., preferably of 20 to 80° C., and more preferably of 40 to 70° C., over a period of 10 minutes up to several hours.

In the case of silyl groups as protective groups, in particular of phenols, the protective group-containing compounds A are heated preferably with at least one acid or fluoride compound, such as NaF, ammonium fluoride or tetrabutylammonium fluoride, at a temperature of 20 to 100° C., preferably of 20 to 80° C., and more preferably of 40 to 70° C. for a period of 10 minutes up to several hours.

As well as binder component A there must be at least one further component B which comprises at least one di- or polyisocyanate.

These may be, for example, di- or polyisocyanates of the kind listed above in connection with the polyurethanes. Preferred di- and polyisocyanates are 1,6-diisocyanatohexane and isophorone diisocyanate, and also their polyisocyanates as listed above, in particular their isocyanurates.

In one particular embodiment of the present invention component B comprises at least one polyisocyanate which comprises at least one compound having at least one isocyanate-reactive group and at least one free-radically polymerizable unsaturated group attached at least partly via allophanate groups.

Polyisocyanates of this kind comprise an allophanate group content (calculated as C₂N₂HO₃=101 g/mol) of 1% to 28% by weight, preferably of 3% to 25% by weight.

Of the compound having at least one isocyanate-reactive group and at least one free-radically polymerizable unsaturated group, which form constituent components of these polyisocyanates, at least 20 mol %, preferably at least 25 mol %, more preferably at least 30 mol %, very preferably at least 35 mol %, in particular at least 40 mol %, and especially at least 50 mol % are attached to allophanate groups.

These polyisocyanates generally have a number-average molar weight Mₙ of less than 10 000 g/mol, preferably of less than 5000 g/mol, more preferably of less than 4000, and very preferably of less than 2000 g/mol (as determined by gel permeation chromatography using tetrahydrofuran and polystyrene as standard).

The compounds having at least one isocyanate-reactive group and at least one free-radically polymerizable unsaturated group may be, for example, monoesters of α,β-unsaturated carboxylic acids, such as acrylic acid, methacrylic acid, crotonic acid, itaconic acid, fumaric acid, maleic acid, acrylamidoglycolic acid, methacrylamidoglycolic acid, or vinyl ethers, preferably (meth)acrylic acid, and more preferably acrylic acid, with diols or polyols which have preferably 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,2-, 1,3- or 1,4-butanediol, 1,5-pentanediol, neopentyl glycol, 1,6-hexanediol, 2-methyl-1,5-pentanediol, 2-ethyl-1,4-butanediol, 1,4-dimethylolcyclohexane, 2,2-bis(4-hydroxycyclohexyl)propane, glycerol, trimethylolethane, trimethylolpropane, trimethylolbutane, pentaerythritol, ditrimethylolpropane, erythritol, sorbitol, poly THF having a molar weight between 162 and 2000, poly-1,3-propanediol having a molar weight between 134 and 400 or polyethylene glycol having a molar weight between 238 and 458. It is additionally possible to use esters or amides of (meth)acrylic acid with amino alcohols, examples being 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid.

Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol mono- and di(meth)acrylate, trimethylolpropane mono- and di(meth)acrylate, pentaerythritol mono-, di-, and tri(meth)acrylate, and 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl (meth)acrylamide, 2-aminopropyl (meth)acrylamide, 3-aminopropyl (meth)acrylamide, 2-hydroxyethyl (meth)acrylamide, 2-hydroxypropyl (meth)acrylamide or 3-hydroxypropyl (meth)acrylamide. Particular preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl (meth)acrylate, and the monoacrylates of polyethylene glycol with a molar mass of 106 to 238.

In one preferred embodiment the compound having at least one isocyanate-reactive group and at least one free-radically polymerizable unsaturated group is selected from the group consisting of 2-hydroxyethyl acrylate, 2-hydroxyethyl methacrylate, 2- or 3-hydroxypropyl acrylate and 1,4-butanediol monoacrylate, 1,2- or 1,3-diacrylate of glycerol, trimethylolpropane diacrylate, pentaerythritol triacrylate, ditrimethylolpropane triacrylate, and dipentaerythritol pentaacrylate, preferably of 2-hydroxyethyl acrylate and 2-hydroxyethyl methacrylate.

The formation of the adduct of isocyanato-functional compound and the compound having at least one isocyanate-reactive group and at least one free-radically polymerizable unsaturated group takes place in general by mixing of the components in any order, if appropriate at elevated temperature.

The compound comprising isocyanate-reactive groups is preferably added here to the isocyanato-functional compound, preferably in two or more steps.

With particular preference the isocyanato-functional compound is introduced to start with and the compounds comprising isocyanate-reactive groups are added. Thereafter it is possible if appropriate to add desired further components.

The reaction is carried out in general at temperatures of between 5 and 100° C., preferably between 20 to 90° C., more preferably between 40 and 80° C., and in particular between 60 and 80° C.

It is preferred here to operate under anhydrous conditions.

Anhydrous here means that the water content of the reaction system is not more than 5% by weight, preferably not more than 3% by weight, and very preferably not more than 1% by weight; with very particular preference it is not more than 0.75% and in particular not more than 0.5% by weight.

The reaction is carried out preferably in the presence of at least one oxygenous gas, examples being air or air/nitrogen mixtures, or mixtures of oxygen or an oxygenous gas with a gas which is inert under the reaction conditions, having an oxygen content of below 15%, preferably below 12%, more preferably below 10%, very preferably below 8%, and in particular below 6% by volume.

The reaction can also be carried out in the presence of an inert solvent, examples being acetone, isobutyl methyl ketone, toluene, xylene, butyl acetate, methoxypropyl acetate or ethoxyethyl acetate. With preference, however, the reaction is carried out in the absence of a solvent.

In one preferred embodiment the reaction is carried out under allophanatization conditions.

In another preferred embodiment compounds are used of the kind described in WO 00/39183, p. 4, l. 3 to p. 10, l. 19, the disclosure content of which is hereby made part of the present specification. Particular preference among these compounds is given to those having as constituent components at least one (cyclo)aliphatic isocyanate which contains allophanate groups, and at least one hydroxyalkyl (meth)acrylate, very particular preference being given to products 1 to 9 in table 1 on p. 24 of WO 00/39183.

The binder components A and B are mixed generally in approximately equimolar amounts, so that the ratio of (Y) and (Z) groups (in total) to isocyanate groups in B is from 5:1 to 1:2, preferably from 3:1 to 1:1.5, more preferably from 2:1 to 1:1.2, very preferably 1.5:1 to 1:1.1, and in particular 1.2:1 to 1:1.1.

A further aspect of the present invention is the use of the binder components A and B in coating formulations for producing coatings which exhibit an effect of repairability by introduction of energy.

This means that scratches, cracks and/or delaminations from the substrate that are formed in the coating are at least partly reversible.

In addition to components A and B, such coating formulations may further comprise:
if appropriate, at least one compound having one or more than one free-radically polymerizable double bond,
if appropriate, at least one photoinitiator, and
if appropriate, further, typical coatings additives.

Compounds having one or more than one free-radically polymerizable double bond are, for example, compounds having 1 to 6, preferably 1 to 4, and more preferably 1 to 3 free-radically polymerizable groups.

Examples of free-radically polymerizable groups include vinyl ether or (meth)acrylate groups, preferably (meth)acrylate groups, and more preferably acrylate groups.

Free-radically polymerizable compounds are frequently subdivided into monofunctional polymerizable compounds (compounds having one free-radically polymerizable double bond) and multifunctional polymerizable compounds (compounds having more than one free-radically polymerizable double bond).

Monofunctional polymerizable compounds are those having precisely one free-radically polymerizable group; multifunctional polymerizable compounds are those having more than one, preferably at least two, free-radically polymerizable groups.

Examples of monofunctional polymerizable compounds are esters of (meth)acrylic acid with alcohols having 1 to 20 carbon atoms, examples being methyl (meth)acrylate, ethyl (meth)acrylate, butyl (meth)acrylate, 2-ethylhexyl (meth)acrylate, 2-hydroxyethyl (meth)acrylate, 2-hydroxypropyl (meth)acrylate, 4-hydroxybutyl (meth)acrylate, dihydrodicyclopentadienyl acrylate, vinylaromatic compounds, e.g., styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g. cyclopentene, cyclohexene, cyclododecene, N-vinylformamide, allylacetic acid, vinylacetic acid, monoethylenically unsaturated carboxylic acids having 3 to 8 carbon atoms and their water-soluble alkali metal, alkaline earth metal or ammonium salts, for example: acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid, N-vinylpyrrolidone, N-vinyl lactams, such as N-vinylcaprolactam, N-vinyl-N-alkylcarboxamides or N-vinylcarboxamides, such as N-vinylacetamide, N-vinyl-N-methylformamide, and N-vinyl-N-methylacetamide, or vinyl ethers, examples being methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, 4-hydroxybutyl vinyl ether, and mixtures thereof.

Preference among these is given to the esters of (meth)acrylic acid, more preferably methyl (meth)acrylate, ethyl (meth)acrylate, n-butyl meth)acrylate, 2-ethylhexyl (meth)acrylate, and 2-hydroxyethyl acrylate, very preferably n-butyl (meth)acrylate, 2-ethylhexyl (meth)acrylate, and 2-hydroxyethyl acrylate, and especially 2-hydroxyethyl acrylate.

(Meth)acrylic acid stands in this specification for methacrylic acid and acrylic acid, preferably for acrylic acid.

Multifunctional polymerizable compounds are preferably multifunctional (meth)acrylates which carry more than one, preferably 2-10, more preferably 2-6, very preferably 2-4, and in particular 2-3 (meth)acrylate groups, preferably acrylate groups.

These may be, for example, esters of (meth)acrylic acid with polyalcohols which, correspondingly, are at least dihydric.

Examples of polyalcohols of this kind are at least dihydric polyols, polyetherols or polyesterols or polyacrylate polyols having an average OH functionality of at least 2, preferably 3 to 10.

Examples of multifunctional polymerizable compounds are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3-, and 1,4-cyclohexanedimethanol diacrylate, 1,2-, 1,3- or 1,4-cyclohexanediol diacrylate, trimethylolpropane triacrylate, ditrimethylolpropane penta- or hexaacrylate, pentaerythritol tri- or tetraacrylate, glycerol di- or triacrylate, and also di- and polyacrylates of sugar alcohols, such as sorbitol, mannitol, diglycerol, threitol, erythritol, adonitol (ribitol), arabitol (lyxitol), xylitol, dulcitol (galactitol), maltitol or isomalt, or of polyester polyols, polyetherols, poly THF having a molar mass of between 162 and 2000, poly-1,3-propanediol having a molar mass of between 134 and 2000, polyethylene glycol having a molar mass of between 106 and 2000, and also epoxy (meth)acrylates, urethane (meth)acrylates or polycarbonate (meth)acrylates.

Further examples are (meth)acrylates of compounds of formula (VIIIa) to (VIIIc)

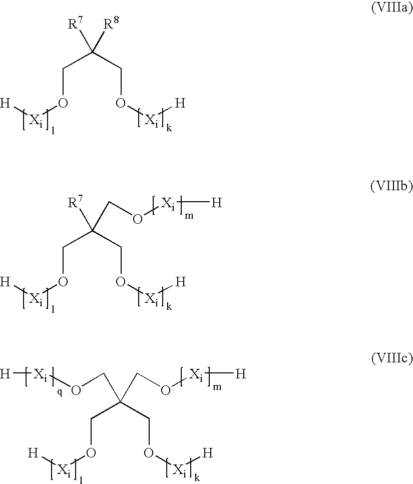

in which

R⁷ and R⁸ independently of one another are hydrogen or are C₁-C₁₈ alkyl which is unsubstituted or substituted by aryl, alkyl, aryloxy, alkyloxy, heteroatoms and/or heterocycles,

k, l, m, and q independently of one another are each an integer from 1 to 10, preferably 1 to 5, and more preferably 1 to 3, and

each Xᵢ for i=1 to k, 1 to l, 1 to m, and 1 to q can be selected independently of one another from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—C—, —CH₂—CH(CH₃)—O—, and —CH(CH₃)—CH₂—O—, and more preferably —CH₂—CH₂—O—,

in which Ph is phenyl and Vin is vinyl.

C₁-C₁₈ alkyl therein, unsubstituted or substituted by aryl, alkyl, aryloxy, alkyloxy, heteroatoms and/or heterocycles, is for example methyl, ethyl, propyl, isopropyl, n-butyl, sec-butyl, tert-butyl, pentyl, hexyl, heptyl, octyl, 2-ethylhexyl, 2,4,4-trimethyl-pentyl, decyl, dodecyl, tetradecyl, hetadecyl, octadecyl, 1,1-dimethylpropyl, 1,1-dimethylbutyl, 1,1,3,3-tetramethylbutyl, preferably methyl, ethyl or n-propyl, more preferably methyl or ethyl.

These are preferably (meth)acrylates of singly to vigintuply and more preferably triply to decuply ethoxylated, propoxylated or mixedly ethoxylated and propoxylated, and in particular exclusively ethoxylated, neopentyl glycol, trimethylolpropane, trimethylolethane or pentaerythritol.

Preferred multifunctional polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyester polyol acrylates, polyetherol acrylates, and triacrylate of singly to vigintuply alkoxylated, more preferably ethoxylated, trimethylolpropane.

Very particularly preferred multifunctional polymerizable compounds are 1,4-butanediol diacrylate, 1,6-hexanediol diacrylate, trimethylolpropane triacrylate, pentaerythritol tetraacrylate, and triacrylate of singly to vigintuply ethoxylated trimethylolpropane.

Polyester polyols are known for example from Ullmanns Encyklopädie der technischen Chemie, 4th edition, volume 19, pp. 62 to 65. Preference is given to using polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH, y being a number from 1 to 20, preferably an even number from 2 to 20; more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,3-propanediol having a molar mass between 134 and 2000, poly-1,2-propanediol having a molar mass between 134 and 2000, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if appropriate may have been alkoxylated as described above.

Preferred alcohols are those of the general formula HO—(CH₂)ₓ—OH, x being a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Also suitable, furthermore, are polycarbonatediols, such as may be obtained, for example, by reacting phosgene with an excess of the low molecular weight alcohols specified as constituent components for the polyester polyols.

Also suitable are lactone-based polyesterdiols, which are homopolymers or copolymers of lactones, preferably hydroxyl-terminated adducts of lactones with suitable difunctional starter molecules. Suitable lactones include, preferably, those deriving from compounds of the general formula HO—(CH₂)_{z}—COOH, z being a number from 1 to 20 and it being possible for an H atom of a methylene unit to have been substituted by a C₁ to C₄ alkyl radical. Examples are ε-caprolactone, β-propiolactone, gamma butyrolactone and/or methyl-ε-caprolactone, 4-hydroxybenzoic acid, 6-hydroxy-2-naphthoic acid or pivalolactone, and mixtures thereof. Examples of suitable starter components are the low molecular weight dihydric alcohols specified above as a constituent component for the polyester polyols. The corresponding polymers of ε-caprolactone are particularly preferred. Lower polyesterdiols or polyetherdiols as well can be used as starters for preparing the lactone polymers. In lieu of the polymers of lactones it is also possible to use the corresponding, chemically equivalent polycondensates of the hydroxy carboxylic acids corresponding to the lactones.

The multifunctional polymerizable compound, as recited above, may also comprise urethane (meth)acrylates, epoxy (meth)acrylates or carbonate (meth)acrylates. Urethane (meth)acrylates are obtainable for example by reacting polyisocyanates with hydroxyalkyl (meth)acrylates or hydroxyalkyl vinyl ethers and, if appropriate, chain extenders such as diols, polyols, diamines, polyamines, dithiols or polythiols. Urethane (meth)acrylates which can be dispersed in water without addition of emulsifiers additionally comprise ionic and/or nonionic hydrophilic groups, which are introduced into the urethane by means of constituent components such as hydroxy carboxylic acids, for example.

Urethane (meth)acrylates of this kind comprise as constituent components substantially:
(I) at least one organic aliphatic, aromatic or cycloaliphatic di- or polyisocyanate,
(II) at least one compound having at least one isocyanate-reactive group and at least one free-radically polymerizable unsaturated group, and
(III) if appropriate, at least one compound having at least two isocyanate-reactive groups.

Possible useful components (I), (II), and (III) may be the same as those described above for the polyurethanes.

The urethane (meth)acrylates preferably have a number-average molar weight Mₙ of 500 to 20 000, in particular of 500 to 10 000 and more preferably 600 to 3000 g/mol (determined by gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Epoxy (meth)acrylates are obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxy-propoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

The epoxy (meth)acrylates and epoxy vinyl ethers preferably have a number-average molar weight Mₙ of 200 to 20 000, more preferably of 200 to 10 000 g/mol, and very preferably of 250 to 3000 g/mol; the amount of (meth)acrylic or vinyl ether groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

Carbonate (meth)acrylates comprise on average preferably 1 to 5, especially 2 to 4, more preferably 2 to 3 (meth)acrylic groups, and very preferably 2 (meth)acrylic groups.

The number-average molecular weight Mₙ of the carbonate (meth)acrylates is preferably less than 3000 g/mol, more preferably less than 1500 g/mol, very preferably less than 800 g/mol (determined by gel permeation chromatography using polystyrene as standard, tetrahydrofuran as solvent).

The carbonate (meth)acrylates are obtainable in a simple manner by transesterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

In an analogous way it is also possible to obtain vinyl ether carbonates, by reacting a hydroxyalkyl vinyl ether with carbonic esters and also, if appropriate, with dihydric alcohols.

Also conceivable are (meth)acrylates or vinyl ethers of polycarbonate polyols, such as the reaction product of one of the aforementioned diols or polyols and a carbonic ester and also a hydroxyl-containing (meth)acrylate or vinyl ether.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythrityl mono-, di-, and tri(meth)acrylate.

Suitable hydroxyl-containing vinyl ethers are, for example, 2-hydroxyethyl vinyl ether and 4-hydroxybutyl vinyl ether.

Particularly preferred carbonate (meth)acrylates are those of the formula:

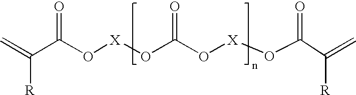

in which R is H or CH₃, X is a C₂-C₁₈ alkylene group, and n is an integer from 1 to 5, preferably 1 to 3.

R is preferably H and X is preferably C₂ to C₁₀ alkylene, examples being 1,2-ethylene, 1,2-propylene, 1,3-propylene, 1,4-butylene, and 1,6-hexylene, more preferably C₄ to C₈ alkylene. With very particular preference X is C₆ alkylene.

The carbonate (meth)acrylates are preferably aliphatic carbonate (meth)acrylates.

Among the multifunctional polymerizable compounds, urethane (meth)acrylates are particularly preferred.

Photoinitiators are compounds which, on irradiation with electromagnetic radiation, form free radicals which have the capacity to initiate a free-radical polymerization. This radiation may be, for example, UV or IR radiation, or electromagnetic radiation in the visible region.

Photoinitiators may be, for example, photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed, for example, by mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitätenchemie), benzophenones, hydroxy-acetophenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracene-7-one, 1-naphthaldehyde, 4,4′-bis(dimethylamino)benzophenone, 4-phenylbenzophenone, 4-chloro-benzophenone, Michler's ketone, 1-acetonaphthone, 2-acetonaphthone, 1-benzoyl-cyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxy-acetophenone, benzil ketals, such as benzil dimethyl ketal, 2-methyl-1-[4-(methyl-lthio)phenyl]-2-morpholinopropan-1-one, anthraquinones such as 2-methyl-anthraquinone, 2-ethylanthraquinone, 2-tert-butylanthraquinone, 1-chloro-anthraquinone, and 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Preference among these photoinitiators is given to 2,4,6-trimethylbenzoyidiphenyl-phosphine oxide, ethyl 2,4,6-trimethylbenzoylphenylphosphinate, bis(2,4,6-trimethyl-benzoyl)phenylphosphine oxide, benzophenone, 1-benzoylcyclohexan-1-ol, 2-hydroxy-2,2-dimethylacetophenone, and 2,2-dimethoxy-2-phenylacetophenone.

IR photoinitiators comprise a sensitizer-coinitiator mixture. As the sensitizer dye it is common to use dyes, especially cyanine, xanthylium or thiazine dyes, and as coinitiators it is common to use, for example, boranate salts, sulfonium salts, iodonium salts, sulfones, peroxides, pyridine N-oxides or halomethyltriazines.

As further typical coatings additives it is possible for example to use antioxidants, stabilizers, activators (accelerants), fillers, pigments, dyes, antistats, flame retardants, thickeners, thixotropic agents, surface-active agents, viscosity modifiers, plasticizers or chelating agents.

It is additionally possible to add one or more thermally activatable initiators, e.g., potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate or benzpinacol, and, for example, those thermally activatable initiators which have a half-life of more than 100 hours at 80° C., such as di-tert-butyl peroxide, cumene hydroperoxide, dicumyl peroxide, tert-butyl perbenzoate, silylated pinacols, which are available commercially, for example, under the trade name ADDID 600 from Wacker, or hydroxyl-containing amine N-oxides, such as 2,2,6,6-tetra-methylpiperidine-N-oxyl, 4-hydroxy-2,2,6,6-tetramethylpiperidine-N-oxyl, etc.

Other examples of suitable initiators are described in “Polymer Handbook”, 2nd ed., Wiley & Sons, New York.

Suitable thickeners include not only free-radically (co)polymerized (co)polymers but also customary organic and inorganic thickeners such as hydroxymethylcellulose or bentonite.

As chelating agents it is possible, for example, to use ethylenediamineacetic acid and its salts, and also β-diketones.

Suitable fillers comprise silicates, examples being silicates obtainable by hydrolysis of silicon tetrachloride, such as Aerosil® from Degussa, silicious earth, talc, aluminum silicates, magnesium silicates, and calcium carbonates, etc.

Suitable stabilizers comprise typical UV absorbers such as oxanilides, triazines, and benzotriazole (the latter obtainable as Tinuvin® grades from Ciba-Spezialitätenchemie), and benzophenones. They can be employed alone or together with suitable free-radical scavengers, examples being sterically hindered amines such as 2,2,6,6-tetramethyl-piperidine, 2,6-di-tert-butylpiperidine or derivatives thereof, e.g., bis(2,2,6,6-tetra-methyl-4-piperidyl) sebacate. Stabilizers are used usually in amounts of 0.1% to 5.0% by weight, based on the solid components comprised in the preparation.

The coating compositions of the invention may be either one-component or two-component. Two-component means here that components A and B, and any other film-forming constituents, are mixed with one another not until a relatively short time prior to application, and then react with one another essentially only after application to the substrate. With two-component coating materials, mixing takes place usually within a period of not more than 12 hours, preferably not more than 10 hours, more preferably not more than 9 hours, very preferably not more than 7 hours, in particular not more than 5 hours, and especially not more than 3 hours prior to application to the substrate.

In contrast to these, one-component (1K) coating compositions can be mixed with one another a relatively long time prior to application. For this purpose it is possible to use existing isocyanate groups in the form of blocked isocyanate groups with common blocking agents (see above).

The coatings obtained with the coating compositions of the invention have a glass transition temperature, T_{g}, of generally above −30° C., preferably above −10° C. The upper limit is situated generally at glass transition temperatures T_{g} of not more than 120° C., preferably not more than 100° C. (by the DSC (differential scanning calorimetry) method in accordance with ASTM 3418/82, heating rate 10° C.).

In one preferred embodiment of the present invention the coating compositions of the invention are radiation-curable or have dual-cure or multi-cure capacity.

The term “dual cure” or “multi cure” refers in the context of this specification to a curing operation which takes place by way of two or more than two mechanisms, respectively, selected for example from radiation curing, moisture curing, chemical curing, oxidative curing and/or thermal curing, preferably from radiation curing, moisture curing, chemical curing and/or thermal curing, more preferably from radiation curing, chemical curing and/or thermal curing, and very preferably radiation curing and chemical curing.

Radiation curing for the purposes of this specification is defined as the polymerization of polymerizable compounds under electromagnetic and/or particulate radiation, preferably UV light in the wavelength range of λ=200 to 700 nm and/or electron beams in the range from 150 to 300 keV, and more preferably with a radiation dose of at least 80, preferably 80 to 3000 mJ/cm².

The coating compositions of the invention are suitable especially for coating substrates such as wood, paper, textile, leather, nonwoven, plastics surfaces, glass, ceramic, mineral building materials, such as cement bricks and fiber cement slabs, and particularly metals, coated or uncoated.

Coating of the substrates with the coating compositions of the invention takes place in accordance with customary methods which are known to the skilled worker and involve applying a coating composition of the invention, or a coating formulation comprising it, to the target substrate in the desired thickness, and, if appropriate, drying it. This operation may if desired be repeated one or more times.

The coating materials may be applied one or more times by a very wide variety of application methods, such as compressed-air, airless or electrostatic spraying methods using one- or two-component spraying units, or else by injecting, trowelling, knifecoating, brushing, rolling, rollercoating, pouring, laminating, injection-backmolding or coextruding.

The coating thickness is generally in a range from about 3 to 1000 g/m² and preferably 10 to 200 g/m².

Additionally disclosed is a method of coating substrates which involves adding, if appropriate, further, typical coatings additives and thermally curable, chemically curable or radiation-curable resins to a coating composition of the invention or to a coating formulation comprising it, applying the resulting formulation to the substrate, drying it if appropriate, and curing it with electron beams or UV exposure under an oxygen-containing atmosphere or, preferably, under inert gas, with thermal treatment if appropriate at temperatures up to the level of the drying temperature and/or at temperatures up to 160° C., preferably between 60 and 160° C.

Radiation curing takes place with high-energy light, UV light for example, or electron beams. Radiation curing may take place at relatively high temperatures. Preference is given in this case to a temperature above the T_{g} of the radiation-curable binder.

Drying and curing of the coatings takes place in general under standard temperature conditions, i.e., without the coating being heated. Alternatively the mixtures of the invention can be used to produce coatings which, following application, are dried and cured at an elevated temperature, e.g., at 40-250° C., preferably 40-150° C., and in particular at 40 to 100° C. This is limited by the thermal stability of the substrate.

Additionally disclosed is a method of coating substrates which involves adding, if appropriate, thermally curable resins to the coating composition of the invention or coating formulations comprising it, applying the resulting formulation to the substrate, drying it, and then curing it with electron beams or UV exposure under an oxygen-containing atmosphere or, preferably, under inert gas, if appropriate at temperatures up to the level of the drying temperature.

The method of coating substrates can also be practiced by irradiating the applied coating composition of the invention or coating formulations of the invention first with electron beams or UV exposure under oxygen or, preferably, under inert gas, in order to obtain preliminary curing, then carrying out thermal treatment at temperatures up to 160° C., preferably between 60 and 160° C., and subsequently completing curing with electron beams or UV exposure under oxygen or, preferably, under inert gas.

If appropriate, if a plurality of layers of the coating material are applied one on top of another, drying and/or radiation curing may take place after each coating operation.

Examples of suitable radiation sources for the radiation cure are low-pressure mercury lamps, medium-pressure mercury lamps with high-pressure lamps, and fluorescent tubes, pulsed lamps, metal halide lamps, electronic flash units, with the result that radiation curing is possible without a photoinitiator, or excimer lamps. The radiation cure is accomplished by exposure to high-energy radiation, i.e., UV radiation, or daylight, preferably light in the wavelength range of λ=200 to 700 nm, more preferably λ=200 to 500 nm, and very preferably λ=250 to 400 nm, or by exposure to high-energy electrons (electron beams; 150 to 300 keV). Examples of radiation sources used include high-pressure mercury vapor lamps, lasers, pulsed lamps (flash light), halogen lamps or excimer lamps. The radiation dose normally sufficient for crosslinking in the case of UV curing is in the range from 80 to 3000 mJ/cm².

It will be appreciated that a number of radiation sources can also be used for the cure: two to four, for example.

These sources may also emit each in different wavelength ranges.

Drying and/or thermal treatment may also take place, in addition to or instead of the thermal treatment, by means of NIR radiation, which here refers to electromagnetic radiation in the wavelength range from 760 nm to 2.5 μm, preferably from 900 to 1500 nm.

The radiation can if appropriate also be carried out in the absence of oxygen, such as under an inert gas atmosphere. Suitable inert gases are preferably nitrogen, noble gases, carbon dioxide, or combustion gases. Furthermore, irradiation may take place by covering the coating composition with transparent media. Examples of transparent media include polymeric films, glass or liquids, water for example. Particular preference is given to irradiation in the manner described in DE-A1 199 57 900.

Where crosslinkers which bring about additional thermal crosslinking are comprised, isocyanates for example, it is possible, at the same time or else after radiation curing, for example, to carry out thermal crosslinking by means of a temperature increase to up to 150° C., preferably up to 130° C.

For the repair (self-healing) of the coatings of the invention the coatings are heated for a time of at least 10 minutes, preferably at least 15 minutes, more preferably at least 20 minutes, very preferably at least 30 minutes, with very particular preference at least 45 minutes, and in particular at least 60 minutes at a temperature which is at least 25° C., preferably at least 30° C., and more preferably at least 35° C. above their glass transition temperature.

Such heating can take place by treatment at a corresponding temperature (in a belt oven or other oven, for example) or may also take place, additionally or exclusively, by heating with NIR radiation, NIR radiation here being electromagnetic radiation in the wavelength range from 760 nm to 2.5 μm, preferably from 900 to 1500 nm.

The coating materials of the invention can be employed in particular as primers, surfacers, pigmented topcoat materials, and clearcoat materials in the segments of industrial coating, especially aircraft coating or large-vehicle coating, wood coating, automotive finishing, especially OEM finishing or refinishing, or decorative coating.

ppm and percentage figures used in this specification are by weight unless otherwise indicated.

The examples below are intended to illustrate the invention but not to limit it to these examples.

### EXAMPLES

### Preparation and Composition of Component A

A 2-liter vessel with pilot stirrer was charged with the solvent and this initial charge was heated to 100° C. Feedstream 1 was started first of all, and was metered in over 1 h 50 min. Then feedstream 2 was started and was continued without interruption over 2 h 45 min. After the end of feedstream 2, feedstream 3 was started at a temperature of 128 to 134° C. The metering of feedstream 3 was over after 2 h 30 min. The polymerization was subsequently continued for a further 3 h at 133 to 136° C. At the end of the reaction, solvent was removed by distillation, giving a solids content of approximately 60%.

| | Example | | |
|---|---|---|---|
| | 1 | 2 | C1 |
| Xylene | 270 parts | 150 parts | 270 parts |
| Feedstream 1 | | | |
| Ethylhexyl methacrylate | 250 parts | 342.9 parts | 390 parts |
| Cyclohexyl methacrylate | 250 parts | | 390 parts |
| 4-(tert-butoxy)styrene | 182.5 parts | 157.1 parts | — |
| Hydroxyethyl acrylate | | — | 120.3 parts |
| Feedstream 2 | | | |
| Xylene | 270 parts | 150 parts | 270 parts |
| Acetone | 100 parts | 50 parts | 100 parts |
| AlBN | 45 parts | 25 parts | 45 parts |
| Feedstream 3 | | | |
| Ethylhexyl methacrylate | 140 parts | — | — |
| Cyclohexyl methacrylate | 140 parts | — | — |
| Solids content | 59.5% | 59% | 58% |

To eliminate the tert-butyl group of the 4-(tert-butoxy)styrene units, 500 g of the solution polymer (examples 1 and 2 only) were heated to 50° C. and 5.9 g of hypophosphorous acid and 17.0 g of p-toluenesulfonic acid were added. The reaction mixture was stirred at 90° C. for 4 h. It was then cooled to about 60° C., diluted with 200 ml of isopropanol, and neutralized with a total of 25 ml of 25% strength ammonia solution. The polymer solution was diluted with isopropanol and the precipitated salt was removed by filtration. The solvent was distilled off under reduced pressure. The resin was then dissolved in n-butyl acetate to give a 50% strength resin solution.

### Two-Component Formulations:

The amounts in the formulation refer to weight fractions in grams unless otherwise indicated. The formulation was prepared by dissolving components A in 50% n-butyl acetate, mixing the solutions with components B and also with the catalyst, DBTL (dibutyltin laurate), and adding the photoinitiator if appropriate. The coatings were applied by means of a wire-wound doctor blade at 150 μm to black-colored glass plates, which allow gloss measurements. The film thickness after drying and curing of the coating films was approximately 60 μm.

The coatings of experimental series “a” were cured by 30-minute heat treatment at 150° C. Curing was ascertained by means of FT-IR spectroscopy on the films, by way of the NCO absorption band at 2250 cm⁻¹.

The formulations of experimental series “b” additionally comprised acrylate groups. Therefore 1-[4-(2-hydroxyethoxy)phenyl]-2-hydroxy-2-methyl-1-propan-1-one was added as photoinitiator and, following thermal curing, the coatings were subjected to UV exposure by means of two medium-pressure mercury UV lamps with an energy of 2×1200 mW/cm². The fully cured coating films were each subjected twice to a scratch test, and then heat-treated at 150° C. for 30 minutes. After each step the relative residual gloss, in percent, was determined by gloss measurement. The untreated coating films served as reference films.

The scratch test was carried out by passing a Scotch-Brite® pad, stretched over a flat metal plate, over the surface of the coating with an applied weight of 750 g. One double rub (back-and-forth stroke) therefore corresponds to a double exposure.

| | Example | | | |
|---|---|---|---|---|
| | 1 | | C1 | |
| | 1a | 1b | C1a | C1b |
| Component A | 20.0 | 20.0 | 17.4 | 17.4 |
| Component B | | | | |
| Isocyanurate(*) | 2.0 | | 2.0 | |
| Polyisocyanato acrylate(**) | | 2.83 | | 2.83 |
| DBTL (%) | 0.02 | 0.02 | 0.02 | 0.02 |
| Photoinitiator | | 0.25 | | 0.25 |
| Gloss measurements | | | | |
| Residual gloss I after 50 | 31.8% | 44.4% | 49.7% | 39.0% |
| double rubs, gloss angle 60° | | | | |
| Residual gloss II after 30 min | 94.1% | 100% | 63.0% | 48.4% |
| at 150° C., gloss angle 60° | | | | |
| Residual gloss III after 50 | 34.3% | 54.9% | 36.0% | 35.0% |
| double rubs, gloss angle 60° | | | | |
| Residual gloss IV after 30 min | 87.4% | 86.5% | 45.0% | 50.1% |
| at 150° C., gloss angle 60° | | | | |

(*)The isocyanurate used was an isocyanurate based on 1,6-hexamethylene diisocyanate, with an NCO content (DIN EN ISO 11909) of about 22.0% by weight and a viscosity of 23° C. (to DIN EN ISO 3219) of about 3200 mPas.
(**)As the polyisocyanato acrylate, preparation took place, as in WO 00/39183, as follows: 1,6-hexamethylene diisocyanate (HDI) was introduced under nitrogen blanketing and this initial charge was admixed with stabilized 2-hydroxyethyl acrylate in an amount such that the product has an acrylate group content of 2 mol/kg. The mixture was heated to 80° C. and 200 ppm by weight (based on diisocyanate) of the catalyst N,N,N-trimethyl-N-(2-hydroxypropyl)ammonium 2-ethylhexanoate were added. The temperature increased slowly to 120° C. Reaction was allowed to take place at this temperature and then stopped by addition of 250 ppm by weight (based on diisocyanate) of di-2-ethylhexyl phosphate, at a conversion rate such that the end product, following removal of the monomer, had an NCO content of 14.9%. The reaction mixture was subsequently freed from unreacted HDI in a thin-film evaporator at 135° C. and 2.5 mbar.

The binder formulations 1 and 2 of the invention gave coatings which are capable under temperature of healing scratches. There is a marked increase in the gloss value. This effect is repeatable. A direct comparison of components A1 and AC1, both of which have a comparable glass transition temperature, shows that with the inventive component A1 it is possible to obtain coating materials having a distinct self-healing effect.

1. A coating composition comprising as constituent components
A) at least one compound having at least two isocyanate-reactive groups (Y), selected from the group consisting of phenols, oximes, N-hydroxyimides, lactams, imidazoles, triazoles, malonic esters, and alkyl acetoacetates, whose reaction product with isocyanate is more readily cleavable than the corresponding reaction product with a compound having primary hydroxyl groups, and also, if appropriate, having at least one further isocyanate-reactive group (Z), which is different from (Y), and
B) at least one di- or polyisocyanate.

2. The coating composition according to claim 1, wherein compound A) comprises 2 to 20 groups (Y).

3. The coating composition according to claim 1, wherein the isocyanate-reactive groups (Z) are selected from the group consisting of primary hydroxyl groups, secondary hydroxyl groups, tertiary hydroxyl groups, primary amino groups, and mercapto groups.

4. The coating composition according to claim 3, wherein up to 5.5 mol of groups (Z) are present in compound A) per kg of compound A).

5. The coating composition according to claim 1, wherein compound A is at least one selected from the group consisting of polyethers, polyesters, polyurethanes, and polyacrylates and (meth)acrylates thereof.

6. The coating composition according to claim 1, wherein compound A comprises at least one polyacrylate.

7. The coating composition according to claim 6, wherein the polyacrylate comprises as constituent components
(a) at least one polymerizable compound having at least one group (Y) or at least one group which can be converted into a group (Y),
(b) at least one ester of a monoalcohol with (meth)acrylic acid,
(c) at least one compound other than (a) and (b) having precisely one free-radically polymerizable C═C double bond,
(d) if appropriate, at least one ester of an alcohol having more than one hydroxyl group with (meth)acrylic acid, and
(e) if appropriate, compounds other than (d) having more than one free-radically polymerizable C═C double bond.

8. The coating composition according to claim 7, wherein the constituent component (a) comprises at least one styrene derivative or cinnamic acid derivative of formula (I) 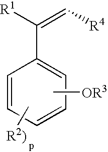
in which
R¹ and R⁴ independently of one another are hydrogen or methyl,
R⁴ is additionally carboxyl (—COOH) or an ester group (—COOR⁵),
R² and R⁵ independently of one another are C₁ to C₂₀ alkyl,
R³ is hydrogen, halogen, C₁ to C₂₀ alkyl, C₁ to C₂₀ alkyloyl, C₁ to C₂₀ aryloyl, C₁ to C₂₀ alkyloxycarbonyl, C₁ to C₂₀ aryloxycarbonyl, C₁ to C₂₀ alkylamidocarbonyl, C₁ to C₂₀ arylamidocarbonyl or trisubstituted silyl, and
p is 0 to 2, preferably 0 to 1, and more preferably 0,
it also being possible for groups —COOR⁵ and —OR³ together to form a —COO— group.

9. The coating composition according to claim 8, wherein the styrene derivative is selected from the group consisting of 4-methoxystyrene, 4-silyloxystyrene, 4-tert-butoxystyrene, 4-tert-amyloxystyrene, 4-acetoxystyrene, 4-hydroxycinnamic acid, and coumarin.

10. The coating composition according to claim 8, wherein at least one compound (c) selected from the group consisting of styrene, vinyl acetate, acrylonitrile, acrylic acid, N-vinylpyrrolidone, N-vinylcaprolactam, and ethyl vinyl ether is present.

11. The coating composition according to claim 1, wherein component B comprises at least one polyisocyanate comprising at least one compound having at least one isocyanate-reactive group and at least one free-radically polymerizable unsaturated group, the compound being attached at least partly via allophanate groups.

12. The coating composition according to claim 1, further comprising
if appropriate, at least one compound having one or more than one free-radically polymerizable double bond,
if appropriate, at least one photoinitiator, and
if appropriate, further, typical coatings additives.

13. A method of producing a coating, comprising mixing binder components A and B according to claim 1 in a ratio of (Y) and (Z) groups (in total) in A to isocyanate groups in B of 5:1 to 1:2 and reacting the mixed components.

14. The method according to claim 13, wherein if appropriates the coating composition is additionally radiation-cured.

15. (canceled)

16. A coating obtainable obtained by mixing and reacting binder components A and B according to claim 1.

17. The coating according to claim 16, having a glass transition temperature of −30 to 120° C.

18. A method of thermally treating a coating according to claim 16, comprising heating the coating for a time of at least 10 minutes at a temperature of at least 25° C. above the glass transition temperature of the coating.

19. The method according to claim 19, wherein heating is carried out using NIR radiation.
